(19) United States
(12) Patent Application Publication
(10) Pub. No.: US 2010/0131457 A1
(43) Pub. Date: May 27, 2010

(54) FLATTENING MULTI-DIMENSIONAL DATA SETS INTO DE-NORMALIZED FORM

(75) Inventor: Scott Heimendinger, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/324,538

(22) Filed: Nov. 26, 2008

(51) Int. Cl. G06F 17/30

(52) U.S. Cl. 707/602; 707/E17.044; 707/E17.056; 707/E17.006

(57) ABSTRACT

Performance metrics data in a multi-dimensional structure such as a nested scorecard matrix is transformed into a flat structure or de-normalized for efficient querying of individual records. Each dimension and header is converted to a column and data values resolved at intersection of dimension levels through an iterative process covering all dimensions and headers of the data structure. A key corresponding to a tuple representation of each cell or a transform of the tuple may be used to identify rows corresponding to the resolved data in cells for further enhanced query capabilities.

### BACKGROUND

Key Performance Indicators (KPIS) are quantifiable measurements that reflect the critical success factors of an organization ranging from income that comes from return customers to percentage of customer calls answered in the first minute. Key Performance Indicators may also be used to measure performance in other types of organizations such as schools, social service organizations, and the like. Measures employed as KPI within an organization may include a variety of types such as revenue in currency, growth or decrease of a measure in percentage, actual values of a measurable quantity, and the like.

Scorecards are used to present calculation of scores that represents performance across KPIs, their actual data, their target settings, their thresholds and other constraints. Scorecards and similar compilations of metrics provide an efficient method to track, compare, analyze, and present performance measures. Data including organizational hierarchies and associated metrics are typically stored (and presented) in nested structures. For example, multidimensional expression language (MDX) is an industry-wide convention for querying data stored in OLAP cubes. A result set provided by an MDX query contains nested sets of dimensions, hierarchies, and dimension members. In this format, it is difficult to programmatically identify a particular cell of data that might be of interest.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to transforming performance metrics data in a nested structure to a flat structure for efficient querying of individual records. Each dimension is converted to a column and data values resolved at intersection of dimension levels through an iterative process covering dimensions and levels of the data structure. According to some embodiments, a key corresponding to a tuple representation of each cell or a transform of the tuple may be used to identify rows corresponding to the resolved data in cells for enhanced query capabilities.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example scorecard architecture, where a flattening process according to embodiments may be implemented;

FIG. 2 illustrates a screenshot of an example scorecard;

FIG. 3 is another example scorecard illustrating nested structure of the performance data;

FIG. 4 illustrates dimension members of the scorecard of FIG. 3, which may be converted to columns in a flattening process according to embodiments may be implemented;

FIG. 5 illustrates a table showing a portion of the data from the scorecard of FIG. 3 in flattened format according to one embodiment;

FIG. 6 illustrates another table showing a portion of the data from the scorecard of FIG. 3 with a tuple key column in flattened format according to another embodiment;

FIG. 7 illustrates yet another table showing a portion of the data from the scorecard of FIG. 3 with a hash key column in flattened format according to a further embodiment;

FIG. 8 is a networked environment, where embodiments may be implemented;

FIG. 9 is a block diagram of an example computing operating environment, where embodiments may be implemented; and

FIG. 10 illustrates a logic flow diagram for flattening multi-dimensional data sets into de-normalized form according to embodiments.

### DETAILED DESCRIPTION

As briefly described above, data in a nested structure may be flattened into a de-normalized form for efficient querying through transformation of dimension members into columns and use of a key to identify rows. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media. The computer program product may also be a propagated signal on a carrier (e.g. a frequency or phase modulated signal) or medium readable by a computing system and encoding a computer program of instructions for executing a computer process.

Throughout this specification, the term “platform” may be a combination of software and hardware components for flattening multi-dimensional data. Examples of platforms include, but are not limited to, a hosted service executed over a plurality of servers, an application executed on a single server, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

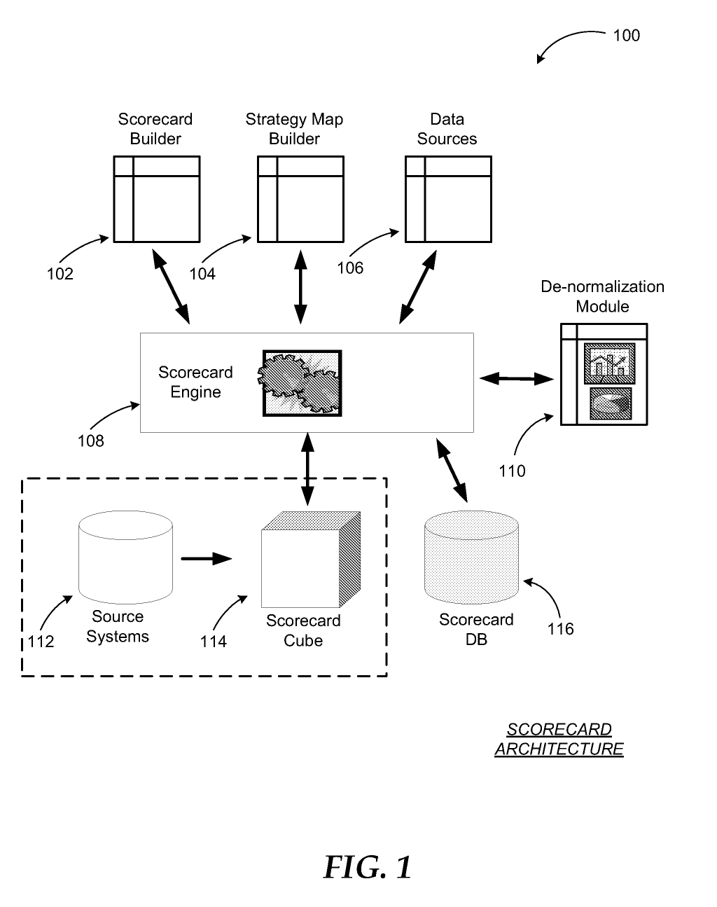

FIG. 1 illustrates example scorecard architecture 100, where a flattening process according to embodiments may be implemented. The scorecard architecture may comprise any topology of processing systems, storage systems, source systems, and configuration systems. The scorecard architecture may also have a static or dynamic topology.

Scorecards are an easy method of evaluating organizational performance. The performance measures may vary from financial data such as sales growth to service information such as customer complaints. In a non-business environment, student performances and teacher assessments may be another example of performance measures that can employ scorecards for evaluating organizational performance. In the exemplary scorecard architecture, a core of the system is scorecard engine 108. Scorecard engine 108 may be an application program that is arranged to evaluate performance metrics. Scorecard engine 108 may be loaded into a server, executed over a distributed network, executed in a client device, and the like.

Data for evaluating various measures may be provided by a data source. The data source may include source systems 112, which provide data to a scorecard cube 114. Source systems 112 may include multi-dimensional databases such OLAP, other databases, individual files, and the like, that provide raw data for generation of scorecards. Scorecard cube 114 is a multi-dimensional database for storing data to be used in determining Key Performance Indicators (KPIs) as well as generated scorecards themselves. As discussed above, the multi-dimensional nature of scorecard cube 114 enables storage, use, and presentation of data over multiple dimensions such as compound performance indicators for different geographic areas, organizational groups, or even for different time intervals. Scorecard cube 114 has a bi-directional interaction with scorecard engine 108 providing and receiving raw data as well as generated scorecards.

Scorecard database 116 is arranged to operate in a similar manner to scorecard cube 114. In one embodiment, scorecard database 116 may be an external database providing redundant back-up database service.

Scorecard builder 102 may be a separate application or a part of a business logic application such as the performance evaluation application, and the like. Scorecard builder 102 is employed to configure various parameters of scorecard engine 108 such as scorecard elements, default values for actuals, targets, and the like. Scorecard builder 102 may include a user interface such as a web service, a GUI, and the like.

Strategy map builder 104 is employed for a later stage in scorecard generation process. As explained below, scores for KPIs and other metrics may be presented to a user in form of a strategy map. Strategy map builder 104 may include a user interface for selecting graphical formats, indicator elements, and other graphical parameters of the presentation. Data Sources 106 may be another source for providing raw data to scorecard engine 108. Data sources 106 may also define KPI mappings and other associated data.

Additionally, the scorecard architecture may include de-normalization module 110. This may be an application or module to transform scorecard data in nested structure into a flat structure for efficient querying of the data. De-normalization module 110 may iterate through dimensions and levels transforming each dimension into a column in a two-dimensional table structure. For additional efficiency a key column based on tuples of cells or a hash of the tuples may also be employed.

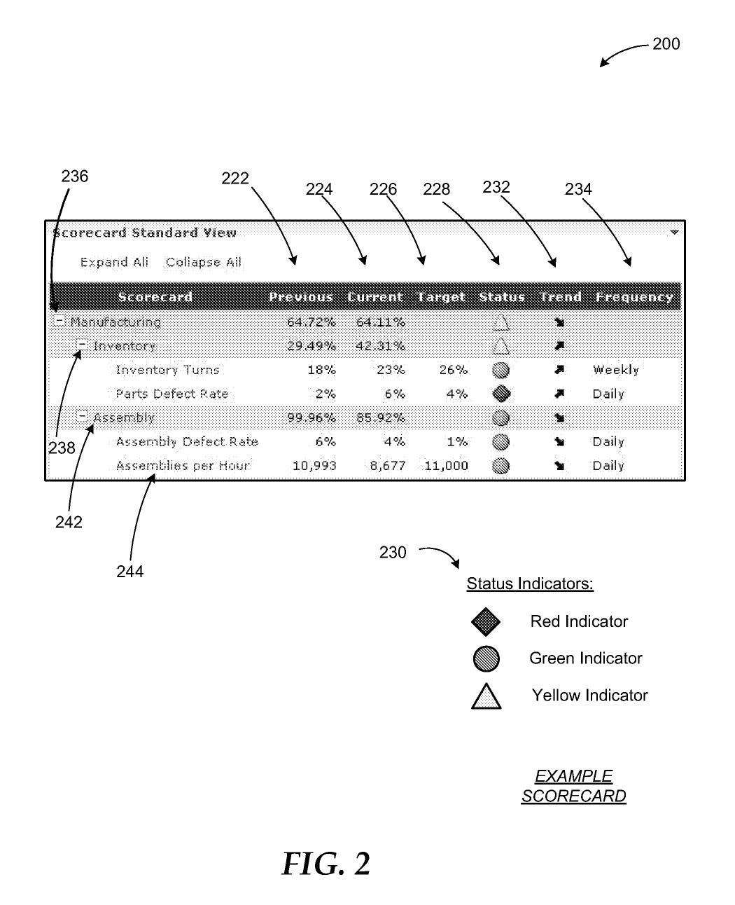

FIG. 2 illustrates a screenshot of example scorecard 200 with status indicators 230. As explained before, Key Performance Indicators (KPIs) are specific indicators of organizational performance that measure a current state in relation to meeting the targeted objectives. Decision makers may utilize these indicators to manage the organization more effectively.

When creating a KPI, the KPI definition may be used across several scorecards. This is useful when different scorecard managers might have a shared KPI in common. This may ensure a standard definition is used for that KPI. Despite the shared definition, each individual scorecard may utilize a different data source and data mappings for the actual KPI.

Each KPI may include a number of attributes. Some of these attributes include frequency of data, unit of measure, trend type, weight, and other attributes. The frequency of data identifies how often the data is updated in the source database (cube). The frequency of data may include: Daily, Weekly, Monthly, Quarterly, and Annually. The unit of measure provides an interpretation for the KPI. Some of the units of measure are: Integer, Decimal, Percent, Days, and Currency. These examples are not exhaustive, and other elements may be added without departing from the scope of the invention.

A trend type may be set according to whether an increasing trend is desirable or not. For example, increasing profit is a desirable trend, while increasing defect rates is not. The trend type may be used in determining the KPI status to display and in setting and interpreting the KPI banding boundary values. The arrows displayed in the scorecard of FIG. 2 indicate how the numbers are moving this period compared to last. If in this period the number is greater than last period, the trend is up regardless of the trend type. Possible trend types may include: Increasing Is Better, Decreasing Is Better, and On-Target Is Better.

Weight is a positive integer used to qualify the relative value of a KPI in relation to other KPIs. It is used to calculate the aggregated scorecard value. For example, if an Objective in a scorecard has two KPIs, the first KPI has a weight of 1, and the second has a weight of 3 the second KPI is essentially three times more important than the first, and this weighted relationship is part of the calculation when the KPIs' values are rolled up to derive the values of their parent metric.

Other attributes may contain pointers to custom attributes that may be created for documentation purposes or used for various other aspects of the scorecard system such as creating different views in different graphical representations of the finished scorecard. Custom attributes may be created for any scorecard element and may be extended or customized by application developers or users for use in their own applications. They may be any of a number of types including text, numbers, percentages, dates, and hyperlinks.

One of the benefits of defining a scorecard is the ability to easily quantify and visualize performance in meeting organizational strategy. By providing a status at an overall scorecard level, and for each perspective, each objective or each KPI rollup, one may quickly identify where one might be off target. By utilizing the hierarchical scorecard definition along with KPI weightings, a status value is calculated at each level of the scorecard.

First column of the scorecard shows example top level metric 236 “Manufacturing” with its reporting KPIs 238 and 242 “Inventory” and “Assembly”. Second column 222 in the scorecard shows results for each measure from a previous measurement period. Third column 224 shows results for the same measures for the current measurement period. In one embodiment, the measurement period may include a month, a quarter, a tax year, a calendar year, and the like.

Fourth column 226 includes target values for specified KPIs on the scorecard. Target values may be retrieved from a database, entered by a user, and the like. Column 228 of the scorecard shows status indicators 230. Status indicators 230 convey the state of the KPI. An indicator may have a predetermined number of levels. A traffic light is one of the most commonly used indicators. It represents a KPI with three-levels of results—Good, Neutral, and Bad. Traffic light indicators may be colored red, yellow, or green. In addition, each colored indicator may have its own unique shape. A KPI may have one stoplight indicator visible at any given time. Other types of indicators may also be employed to provide status feedback. For example, indicators with more than three levels may appear as a bar divided into sections, or bands. Column 232 includes trend type arrows as explained above under KPI attributes. Column 234 shows another KPI attribute, frequency.

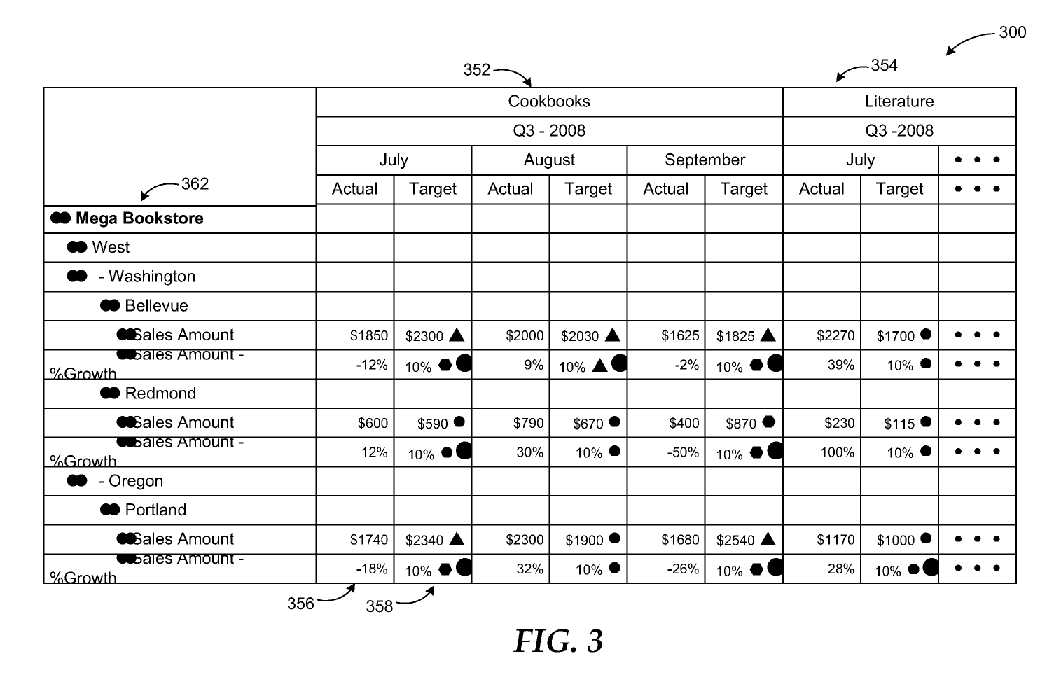

FIG. 3 is another example scorecard 300 illustrating nested structure of the performance data. Scorecard 300 shows sales performance data of different stores for a bookstore. Geographic dimensions are listed in the first column 362 as a nested structure of KPIs for each city, in each state, and in a selected region for the “Mega Bookstore.”

Item categories, for which the sales metrics are tracked, include Cookbooks 352 and Literature 354. Each item category includes layered time dimensions such as quarter and year, month, etc. Metrics for each of the lowest level time dimension include an actual, a target, and a target status. In the example scorecard, target values and target status indicators are shown within the same cell. Thus, each cell may include a value (356) or a value and a status indicator (358).

As mentioned previously, using MDX query result sets are obtained with nested sets of dimensions, hierarchies and dimension members. In this format, it is difficult to programmatically identify a particular cell of data that might be of interest. For example, if a user wished to track the actual Sales Amount for Cookbooks for the Bellevue store in July 2008, traversing the row and column labels programmatically is difficult since the hierarchies contain nested members. According to some embodiment, the data structure is collapsed into a de-normalized format, making it easier to programmatically find the data cell of interest.

The example scorecards, metrics, dimensions, and presentations shown in the figures above and below are for illustration purposes only and do not constitute a limitation on embodiments. Other embodiments using different scorecards, metrics, dimensions, presentations, and similar elements may be implemented without departing from a scope and spirit of the disclosure.

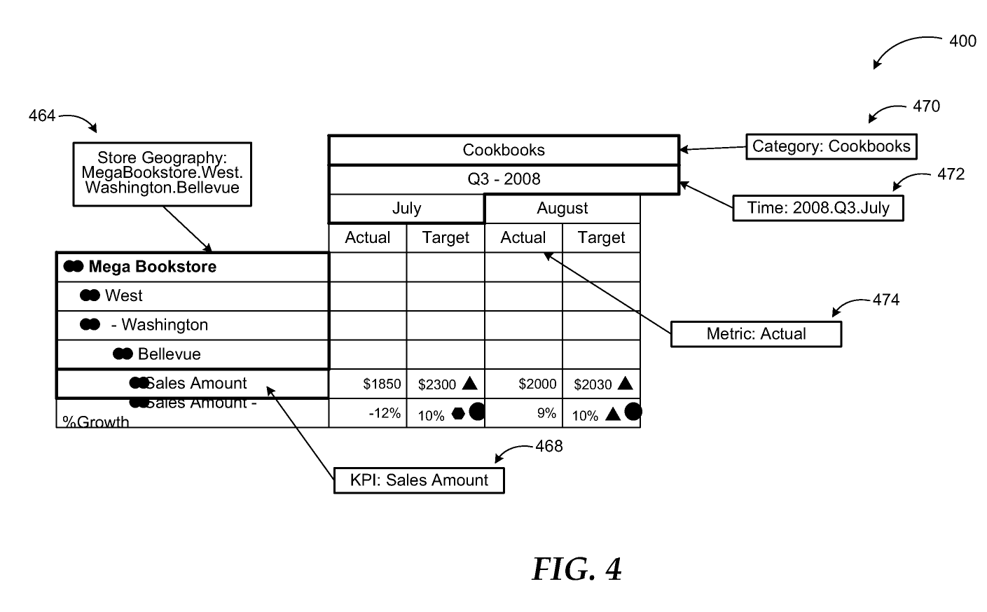

FIG. 4 illustrates dimension members and headers of the scorecard of FIG. 3, which may be converted to columns in a flattening process according to embodiments may be implemented. Performance metrics data in a nested structure may be transformed to a flat structure by converting each dimension to a column and resolving data values at the intersection of dimension levels through an iterative process covering all dimensions and headers of the data structure.

As shown in diagram 400, the dimensions and headers of the example scorecard 300 of FIG. 3 include store geography 464 with its levels of store, region, state, and city. Other dimensions that may be used to generate columns of the de-normalized table include KPIs (e.g. Sales Amount 468), Categories (e.g. Cookbooks 470), Time (each combination of all levels: e.g. 2008.Q3.July 472), and Metrics (e.g. Actual 474).

A two dimensional de-normalized data structure based on a nested scorecard structure may be generated by creating a column for each dimension and level. According to other embodiments, combinations of particular members may be used to generate a column. For example, as shown in the table 500 of FIG. 1, time members (year, quarter, month, etc.) may each be assigned a different column. On the other hand, a column may include combinations of those time members such as a year.quarter.month column. Both alternatives would yield the same granularity for cell level data.

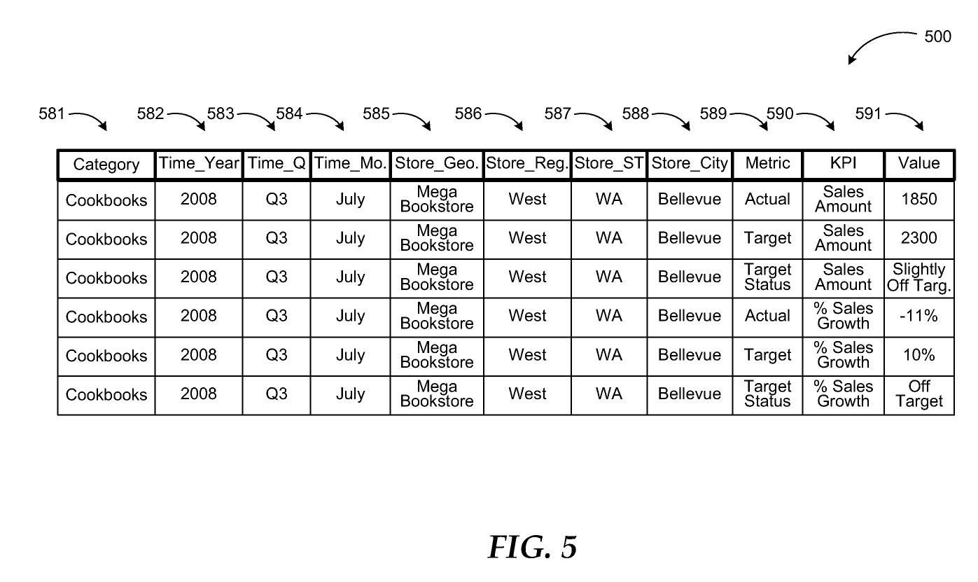

FIG. 5 illustrates a table showing a portion of the data from the scorecard of FIG. 3 in flattened format according to one embodiment. Table 500 is an example of each dimension and header being converted to a distinct column in flattening the nested structure. Columns 581 through 591 include values for categories, time (year), time (quarter), time (month), store geography, store region, store state, store city, metric, KPI, and finally the value, respectively.

Thus, table 500 includes all of the data at the cellular granularity level as nested scorecard matrix 300. However, since the data in table 500 is two dimensional, querying values for each cell can be done rapidly by filtering all rows based on a predefined criterion for a sought cell (e.g. cookbooks.2008.Q3.July.Mega_Bookstore.West.WA.Bellevue.Target. Sales_Amount).

An algorithm for transforming a multi-dimensional data structure into a de-normalized (or flattened) data structure begins with determination of an identifier for the dimension to which each header cell belongs, an identifier for the dimension hierarchy to which each header cell belongs, an identifier for the dimension hierarchy level to which each header cell belongs, and an identifier for the unique dimension member which each header cell represents. An example algorithm may be as follows:

```
1) Create a 2 dimensional data structure (Data Table, 2D Array, etc.)
to store the output
2) In the input data structure, identify each unique OLAP dimension
represented in the column header area. (e.g. [Category] and [Time])
3) In the input data structure, identify each unique OLAP dimension
represented in the row header area. (e.g. [Store Geography])
4) With the union of the results from steps 1 and 2
    a) For each OLAP dimension
        i) Identify each OLAP dimension hierarchy that appears in the
        data set. (For the Time dimension: [Year], [Quarter] and
        [Month])
        ii) Create a column in the output data structure. Name this
        column in a way that uniquely identifies the dimension
        hierarchy. (e.g. [Time_Year])
5) In the input data structure, identify each unique metric (measure, value,
KPI) represented in the column header area. (e.g. [Actual] and [Target])
6) In the input data structure, identify each unique metric (measure, value,
KPI) represented in the row header area. (e.g. [Sales Amt] and [Sales
Amt − % Growth PP])
7) With the union of the results from steps 5 and 6
    a) For each metric
        i) Create a column in the output data structure. Name this
        column in a way that uniquely identifies the metric. (e.g.
        [Actual] or [Metric_Actual])
8) Create a column in the output data structure called “Value” to
contain the value of each cell in the input data structure.
```

Another aspect of flattening data sets into de-normalized form is its independence from an origin of data in the scorecard. Data in a scorecard matrix may be received from a multi-dimensional data source or from a flat data source and formatted into the nested structure as discussed previously. Since the de-normalization process according to embodiments takes data from the nested structure of a scorecard matrix, the origin of the data does not influence the flattening.

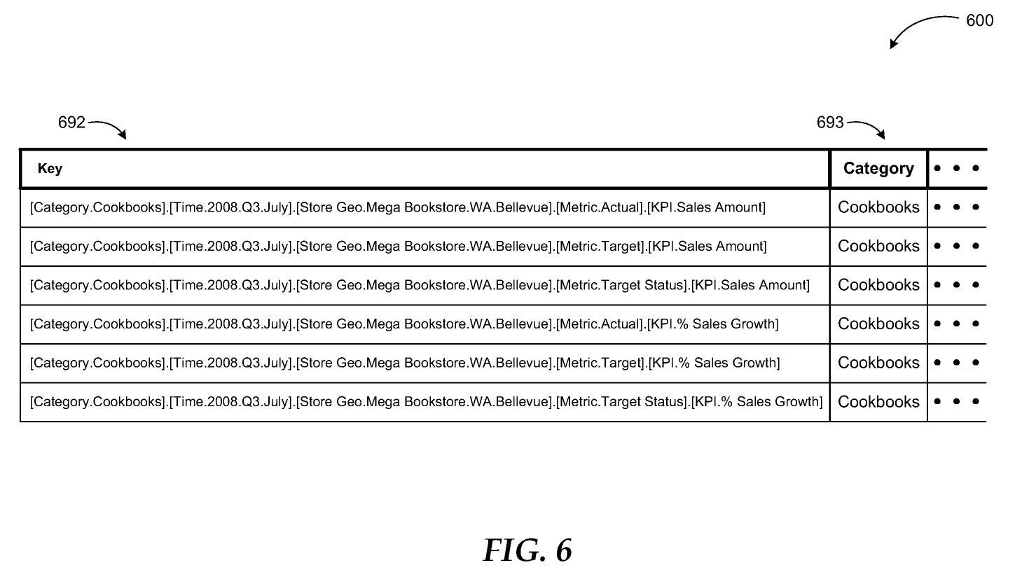

FIG. 6 illustrates another table 600 showing a portion of the data from the scorecard of FIG. 3 with a tuple key column in flattened format according to another embodiment. To increase search efficiency in flattened data structures according to embodiment even further, a key column 692 may be utilized. The value of the key is a composition of the exact dimensionality of the cell, also known as the cell's tuple. The tuple may be specified in a readable form, as in table 600 or by generating a hash of the readable tuple to produce a shorter key. Other columns of table 600 include dimension and header based columns of table 500 such as category column 693.

The example algorithm described above may be expanded to include key values as follows:

```
9) Create a column called “Key” in the output data structure to contain a
unique identifier for each row in the output data structure
10) In the input data structure, for each cell in the data area
(non-header cell)
    a) Create a new row in the output data structure
    b) For each dimension hierarchy
        i) Write the metric name at associated with the cell into the
        corresponding column in the output data structure (For
        example, the dimension member “Bellevue” may be written
        into the [Store_City] column of the output data structure)
    c) For each metric, if the metric is in the same row or column as the
    cell
        i) Write the dimension member at the current dimension
        hierarchy into the corresponding column in the output data
        structure (For example, the metric “Sales Amount” may be
        written into the [KPI] column of the output data structure,
        since Sales Amount is a KPI)
    d) Write the value of the cell into the Value column
```

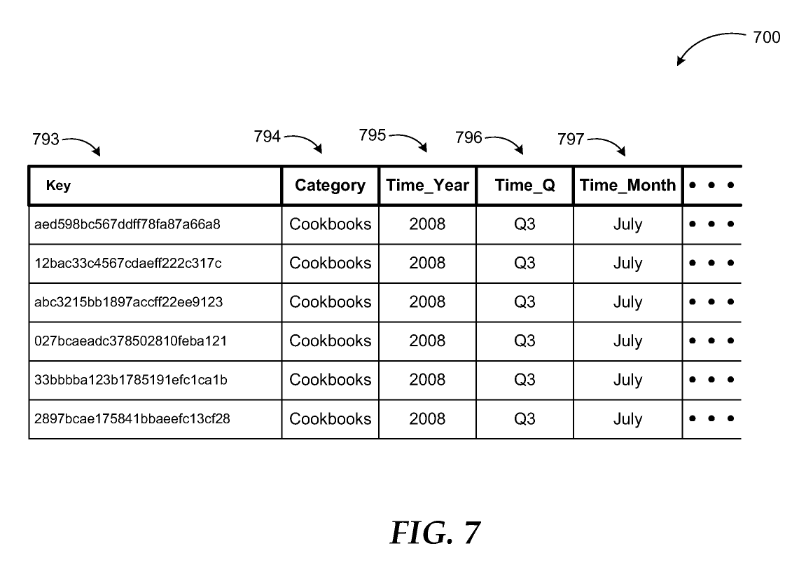

FIG. 7 illustrates yet another table showing a portion of the data from the scorecard of FIG. 3 with a hash key column in flattened format according to a further embodiment. As mentioned above and shown in FIG. 6, the key values may be relatively large if they include the unique identifier of the cells based on the dimensions and headers.

According to some embodiments, the key values may be transformed such as a hash value and the shorter, easier to handle value may be used. In the example table 700, key values column 793 includes hash transformations of the key values based on cell identifiers. Other columns (similar to columns 500 and 600) include values for dimensions and headers such as category 794, time_year 795, time_quarter 796, time_month 797, and so on.

Step 10 of the algorithm discussed above may be expanded with the following sub-steps to employ hash or transformed key values:

```
e) Generate a value for the Key column
    i) By concatenating the names and values of all other columns
    except the Value column into a single, delimited string, or
    ii) By concatenating the names and values of all other columns
    except the Value column into a delimited string, then using a
    hashing algorithm to produce a digested version of the string.
f) Write the generated key value into the Key column.
```

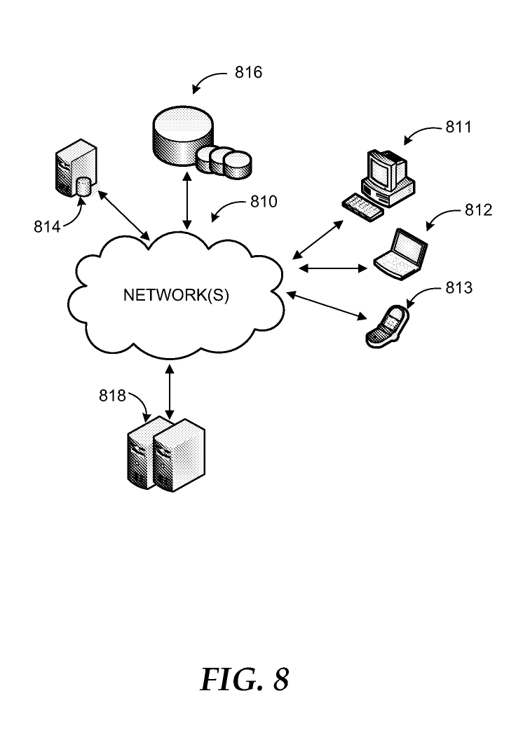

FIG. 8 is a networked environment, where embodiments may be implemented. A platform providing performance based metrics services may be implemented via software executed over one or more servers 818 such as a hosted service. The platform may communicate with client applications on individual computing devices such as a smart phone 813, a laptop computer 812, and desktop computer 811 (client devices) through network(s) 810.

Client devices 811-813 may be used to provide access for users to a hosted service for providing input associated with performance metrics or receive analysis results, presentations, and similar metrics based operation results. Performance metrics data in nested structures such as a scorecard matrix may be de-normalized as discussed in detail previously by a performance monitoring server or by a client device for example. Data associated with the metrics, dimensions, and other parameters of the system may be stored in one or more data stores (e.g. data store 816), which may be managed by any one of the servers 818 or by database server 814.

Network(s) 810 may comprise any topology of servers, clients, Internet service providers, and communication media. A system according to embodiments may have a static or dynamic topology. Network(s) 810 may include a secure network such as an enterprise network, an unsecure network such as a wireless open network, or the Internet. Network(s) 810 may also coordinate communication over other networks with additional servers, client devices, and other specialized computing devices. Network(s) 810 provides communication between the nodes described herein. By way of example, and not limitation, network(s) 810 may include wireless media such as acoustic, RF, infrared and other wireless media.

Many other configurations of computing devices, applications, data sources, and data distribution systems may be employed to implement a system for flattening multi-dimensional data sets into de-normalized form. Furthermore, the networked environments discussed in FIG. 8 are for illustration purposes only. Embodiments are not limited to the example applications, modules, or processes.

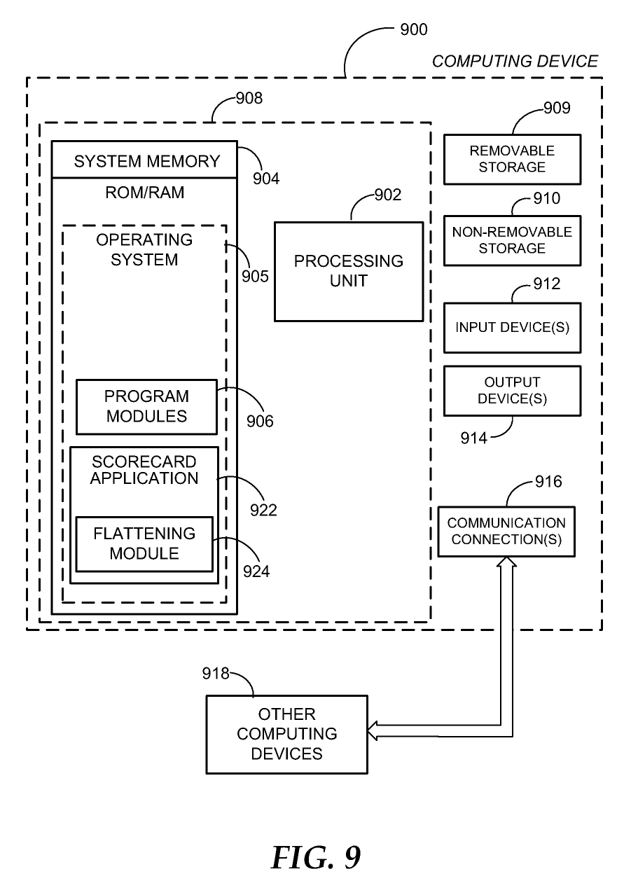

FIG. 9 and the associated discussion are intended to provide a brief, general description of a suitable computing environment in which embodiments may be implemented. With reference to FIG. 9, a block diagram of an example computing operating environment for an application according to embodiments is illustrated, such as computing device 900. In a basic configuration, computing device 900 may be a server in a business system and include at least one processing unit 902 and system memory 904. Computing device 900 may also include a plurality of processing units that cooperate in executing programs. Depending on the exact configuration and type of computing device, the system memory 904 may be volatile (such as RAM), non-volatile (such as ROM, flash memory, etc.) or some combination of the two. System memory 904 typically includes an operating system 905 suitable for controlling the operation of the platform, such as the WINDOWS® operating systems from MICROSOFT CORPORATION of Redmond, Wash. The system memory 904 may also include one or more software applications such as program modules 906, scorecard application 922, and flattening module 924.

Scorecard application 922 and flattening module 924 may be separate applications or integral modules of a hosted service that provides performance metrics based services to client applications/devices. Scorecard application 922 may compose, analyze, present scorecards and perform other operations. Flattening module 924 may transform multi-dimensional performance data such as a nested structure into a two dimensional structure. This basic configuration is illustrated in FIG. 9 by those components within dashed line 908.

Computing device 900 may have additional features or functionality. For example, the computing device 900 may also include additional data storage devices (removable and/or non-removable) such as, for example, magnetic disks, optical disks, or tape. Such additional storage is illustrated in FIG. 9 by removable storage 909 and non-removable storage 910. Computer readable storage media may include volatile and nonvolatile, removable and non-removable media implemented in any method or technology for storage of information, such as computer readable instructions, data structures, program modules, or other data. System memory 904, removable storage 909 and non-removable storage 910 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 900. Any such computer readable storage media may be part of computing device 900. Computing device 900 may also have input device(s) 912 such as keyboard, mouse, pen, voice input device, touch input device, and comparable input devices. Output device(s) 914 such as a display, speakers, printer, and other types of output devices may also be included. These devices are well known in the art and need not be discussed at length here.

Computing device 900 may also contain communication connections 916 that allow the device to communicate with other devices 918, such as over a wireless network in a distributed computing environment, a satellite link, a cellular link, and comparable mechanisms. Other devices 918 may include computer device(s) that execute communication, data storage, analysis, presentation, and similar applications associated with performance metrics. Communication connection(s) 916 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

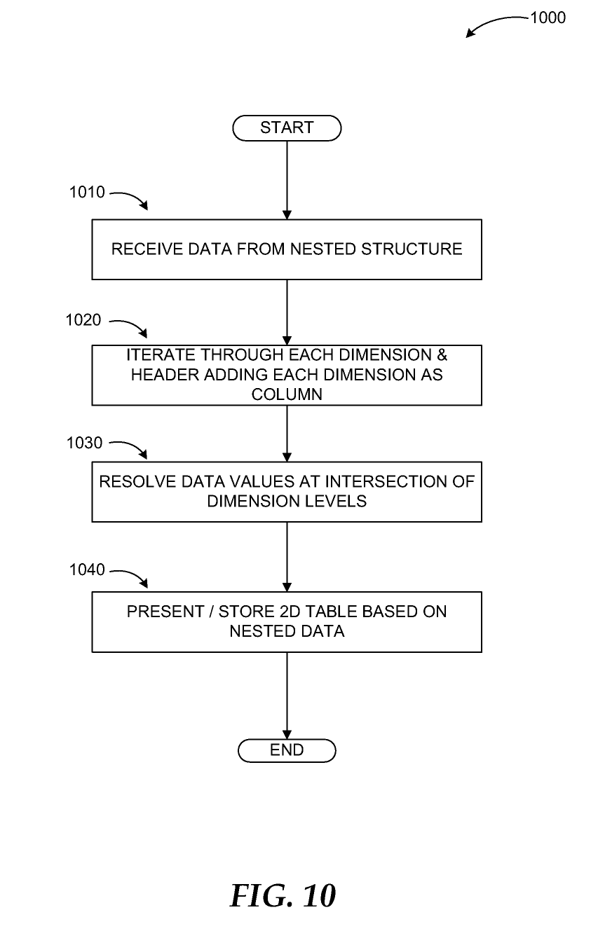

FIG. 10 illustrates logic flow diagram 1000 for flattening multi-dimensional data sets into de-normalized form according to embodiments. Process 1000 may be implemented at a server as part of a performance monitoring system such as the one described above in conjunction with FIG. 8.

Process 1000 begins with operation 1010, where data is received from a multi-dimensional structure such as a nested scorecard matrix. Dimensions and headers for various levels may be also determined at this stage. Processing proceeds to operation 1020 from operation 1010.

At operation 1020, each dimension and header (of all levels) are converted to a column while an algorithm performing the transformation iterates through the dimensions and headers of the nested structure. Processing continues to operation 1030 from operation 1020.

At operation 1030, data values at the intersections of dimension levels are resolved and inserted into appropriate columns and rows in the two dimensional data structure created through the transformation of the original multi-dimensional structure. Processing advances to operation 1040 from operation 1030.

At operation 1040, the two dimensional data structure based on the nested input data structure is stored or presented to another application for further processing of the data. As discussed previously, such searches in a data structure may be performed more efficiently and rapidly. The operations included in process 1000 are for illustration purposes. Transforming multi-dimensional data into two-dimensional data may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for de-normalizing multi-dimensional data, the method comprising:
receiving data from a multi-dimensional data structure at a processor;
transforming the received data to be provided in a two-dimensional data structure by:
iterating through each column dimension and row dimension hierarchy in the multi-dimensional data structure identifying each unique dimension;
iterating through each column metric and row metric in the multi-dimensional data structure identifying each unique metric;
creating a column for each identified unique dimension and metric; and
creating a value column to include data corresponding to each uniquely identified metric and dimension combination; and
outputting the data in the two-dimensional data structure.

2. The method of claim 1, further comprising:
creating a column in the output two-dimensional data structure for key values, wherein each key value is used to identify a corresponding value cell on the same row in the two-dimensional data structure.

3. The method of claim 2, wherein the key value comprises a composition of a dimensionality of the corresponding value cell in the multi-dimensional data structure.

4. The method of claim 3, further comprising:
generating a hash value from each key value; and
inserting the hash value in place of each corresponding key value.

5. The method of claim 1, wherein the multi-dimensional data structure includes a nested scorecard matrix, and wherein the two-dimensional data structure includes a table.

6. The method of claim 1, wherein transforming the received data further includes determining at least one hierarchy for each column and at least one other hierarchy for each row of the multi-dimensional data structure.

7. The method of claim 1, wherein the data in the value column includes at least one from a set of: an alphanumeric value, a numeric value, and a graphic value.

8. The method of claim 1, wherein the output two-dimensional data structure is stored for use in at least one from a set of: an analysis application, a forecast application, and a presentation application.

9. The method of claim 1, wherein the multi-dimensional data structure is a data cube.

10. A computer-readable storage medium with instructions stored thereon for de-normalizing multi-dimensional performance metrics data, the instructions comprising:
generating a two-dimensional output data structure;
determining each unique dimension represented in a column area and in a row area of a multi-dimensional input data structure;
determining each unique dimension hierarchy in the multi-dimensional input data structure;
creating a column for each unique dimension hierarchy in the two-dimensional output data structure;
determining each unique metric represented in the column area and in the row area of the multi-dimensional input data structure;
creating a column for each unique metric in the two-dimensional output data structure; and
creating a value column in the two-dimensional output data structure for representing metric values in the multi-dimensional input data structure.

11. The computer-readable storage medium of claim 10, wherein the columns are created and the unique dimensions and metrics are determined in an iterative process.

12. The computer-readable storage medium of claim 11, wherein the iterative process follows an order of dimensions and metrics as represented in the multi-dimensional input data structure.

13. The computer-readable storage medium of claim 10, wherein the instructions further comprise:
creating a key column in the two-dimensional output data structure for identifying each row;
generating a key value for each row of the key column based on concatenating data from the columns for the dimensions and the columns for the metrics on each row.

14. The computer-readable storage medium of claim 13, wherein the instructions further comprise:
applying a unique transformation to the data in the key column; and
replacing the key values with transformed values, wherein the transformed values are shorter than the key values.

15. The computer-readable storage medium of claim 10, wherein the dimensions include at least one from a set of: an organizational unit, an organization geography, and a time period.

16. The computer-readable storage medium of claim 10, wherein the multi-dimensional input data structure is a collapsible nested data matrix.

17. A system for de-normalizing multi-dimensional scorecard data, the system comprising:
a data store for storing two-dimensional and multi-dimensional data;
a server including a memory and a processor coupled to the memory, the processor configured to:
iteratively transform scorecard data stored in a multi-dimensional input data structure by;
determining dimensions and metrics along a column and a row of the multi-dimensional input data structure;
creating columns for each of the dimensions and metrics in a two-dimensional output data structure; and
creating a value column in the two-dimensional output data structure representing data in cells uniquely defined by combinations of the dimensions and metrics;
a client device for executing a client application, the client application configured to:
provide input data and configuration parameters for scorecard computations;
receive at least a portion of the two-dimensional output data structure; and
perform user requested operations on the received portion of the two-dimensional output data structure.

18. The system of claim 17, wherein the processor is further configured to iteratively transform the scorecard data by:
determining whether a dimension includes a sub-dimension hierarchy; and
if the dimension includes a sub-dimension hierarchy, creating columns for each sub-dimension in the two-dimensional output data structure.

19. The system of claim 17, wherein the two-dimensional output data structure includes one of a table and a two-dimensional array.

20. The system of claim 17, wherein the data in the multi-dimensional input data structure is received from a two-dimensional data source.
